(19) United States
(12) Patent Application Publication
(10) Pub. No.: US 2015/0161350 A1
(43) Pub. Date: Jun. 11, 2015

(54) SELECTABLE MESSAGE BARCODE FOR HEALTHCARE

(71) Applicant: INTERNATIONAL BUSINESS MACHINES CORPORATION, ARMONK, NY (US)

(72) Inventors: Hung-Yang Chang, Scarsdale, NY (US); Jian-Ren Chen, Hsinchu (TW); Pei-Yun Sabrina Hsueh, New York, NY (US); Su-Chen Huang, Taoyuan (TW); Yu-Shan Huang, New Taipei (TW); June-Ray Lin, Taipei (TW)

(73) Assignee: INTERNATIONAL BUSINESS MACHINES CORPORATION, ARMONK, NY (US)

(21) Appl. No.: 14/098,780

(22) Filed: Dec. 6, 2013

(51) Int. Cl. G06F 19/00; G06K 19/06; H04W 4/00

(52) U.S. Cl. CPC G06F 19/3456; H04W 4/008; G06K 19/06037

(57) ABSTRACT

A device, method, and optical machine-readable code for providing context-aware guidance for healthcare. The device includes: a wireless communication module configured to receive contextual information pertaining to a user's health from one or more devices; an optical code reader to read an optical code encoded with a plurality of healthcare guidance messages; a processor to decode the optical code encoded with the plurality of healthcare guidance messages into a selected context-aware healthcare guidance message using the received contextual information pertaining to the user's health; and a screen for providing the selected context-aware healthcare guidance message to the user. The optical machine-readable code including: an optical code storing a plurality of healthcare guidance messages and encoded in a manner that one of the plurality of healthcare guidance messages can be selected using a decode key, wherein the optical code is provided on a container for medication.

### BACKGROUND OF THE INVENTION

1. Field of the Invention

The present invention relates to the field of healthcare, and more specifically, the present invention relates to a method and system for a selectable message barcode that provides medicine taking guidance.

2. Description of Related Art

In the field of healthcare, real-time alerts to medical personnel during the actual processes of care can reduce the number of negative patient events and are therefore often employed in hospitals. However, once a patient leaves a healthcare facility, the patient can only take the medicine they are prescribed and follow instructions given based on patient history and a hypothesis determined at a previous time, not real-time or context-aware conditions.

New patient prescriptions must be adapted based on time and new biographical data that is detected relating to the patient. Currently, prescriptions, which are often marked with optical codes or barcodes, cannot provide accurate updated guidelines or instructions for patients to follow based on new information obtained from up-to-date measurements and data. Rather the barcodes are primarily used solely as pharmacist or patient medication identification tags to avoid ordering and dispensing errors.

Optical code can include a barcode. A barcode is a symbol including a pattern of bars/lines, spaces, and other symbols that are typically read by barcode readers/ optical code readers and laser scanning systems to decode the optical code into a multiple digit representation of a value. The routine application of barcodes in daily life is becoming more apparent. Barcodes are mostly used in manufactured products, however, they are commonly used in checks, online posts, books, and other areas. Barcodes can be imprinted on almost any surface and be read accurately even if in a slant state.

### BRIEF SUMMARY OF THE INVENTION

One aspect of the present invention provides a device for providing context-aware guidance for healthcare. The device including: a wireless communication module configured to receive contextual information pertaining to a user's health from one or more devices; an optical code reader to read an optical code encoded with a plurality of healthcare guidance messages; a processor to decode the optical code encoded with the plurality of healthcare guidance messages into a selected context-aware healthcare guidance message using the received contextual information pertaining to the user's health; and a screen for providing the selected context-aware healthcare guidance message to the user

Another aspect of the present invention provides a method of providing context-aware guidance for healthcare, the method including: receiving contextual information pertaining to a user's health from one or more devices; reading an optical code using an optical code reader, wherein the optical code is encoded with a plurality of healthcare guidance messages; decoding the optical code encoded with the plurality healthcare guidance messages into a selected context-aware healthcare guidance message using the received contextual information pertaining to the user's health; and providing the selected context-aware healthcare guidance message to the user.

Another aspect of the present invention provides an optical machine-readable code for providing context-aware guidance for healthcare, the code including: an optical code storing a plurality of healthcare guidance messages and encoded in a manner that one of the plurality of healthcare guidance messages can be selected using a decode key, wherein the optical code is provided on a container for medication.

### BRIEF DESCRIPTION OF THE DRAWINGS

FIG. 1 shows a flowchart illustrating a method of providing context-aware guidance for healthcare according to embodiments of the present invention.

FIG. 2 is a detailed flowchart illustrating various types of contextual information pertaining to a user's health used to determine a selected context-aware healthcare guidance message according to embodiments of the present invention.

FIG. 3 is a computer system server for providing context-aware guidance for healthcare according to embodiments of the present invention.

FIG. 4 is a detailed flowchart illustrating encoding a plurality of context-aware healthcare guidance messages into optical code and decoding and displaying a selected context-aware healthcare guidance message according to embodiments of the present invention.

FIG. 5 shows key masks used to encode and decode messages within a barcode according to embodiments of the present invention.

FIG. 6 depicts a cloud computing environment according to embodiments of the present invention.

### DETAILED DESCRIPTION OF THE PREFERRED EMBODIMENTS

The present invention provides a device and method for providing context-aware guidance for healthcare. In the present invention a wireless communication module receives contextual information pertaining to a user's health. The contextual information can be sent from one or more devices. An optical code reader reads optical code encoded with healthcare guideline messages. A processor decodes the optical code that is encoded with healthcare guideline messages into a selected context-aware healthcare guideline message by using the contextual information pertaining to the user's health. A screen provides the selected context-aware healthcare guidance message to the user.

According to embodiments of the present invention the devices can be a cellular mobile device. The devices can be any device with wireless or WiFi capabilities. The wireless communication module can include a module for communicating in a Near Field Communication (NFC) network. A NFC allows radio communication between mobile devices by bringing the devices within close proximity to each other.

The optical code encoded with healthcare guidance messages can be a barcode, according to embodiments of the present invention. The barcode can be a one-dimensional barcode or a two-dimensional barcode. Furthermore, the barcode can be in color or in black and white. The optical code can be provided on a container for medication.

The optical machine-readable code provides context-aware guidance for healthcare. The optical machine-readable code stores a plurality of healthcare guidance messages encoded in a manner that one of the plurality of healthcare guidance messages is selected, using a decode key. The message is decoded and displayed to a user.

According to embodiments of the present invention, selecting one of the plurality of healthcare guidance messages using a decode key includes receiving contextual information pertaining to a user's heath. Using the contextual information a context-aware healthcare guidance message is selected. A codify string pertaining to the context-aware healthcare guidance message is extracted and a key mask is generated using the codify string. Using the key mask a decode key is obtained and the message is decoded and received.

According to embodiments of the present invention, the plurality of healthcare guidance messages can be packaged in a Cloud service database that is systemically, dynamically updated to provide up-to-date guidance.

The present invention provides a context-aware medicine administration framework. The benefits of the present invention include reducing medical errors by users since the decoded message would retrieve accurate guidelines relating to a medical condition. For example, a user would not over medicate, believing that the prescribed mediation was not strong enough because the instruction would be based on contextual information and the user would be aware of that fact. Additionally, the present invention provides localized intelligence, since the guidelines are retrieved from a database. The present invention has the potential to teach and illustrate correct usage, while reducing errors.

Embodiments of the present invention will now be described below with reference to the accompanying drawings. In the following description, elements that are identical are referenced by the same reference numbers in all the drawings unless noted otherwise. The configurations explained here are provided as preferred embodiments, and it should be understood that the technical scope of the present invention is not intended to be limited to these embodiments.

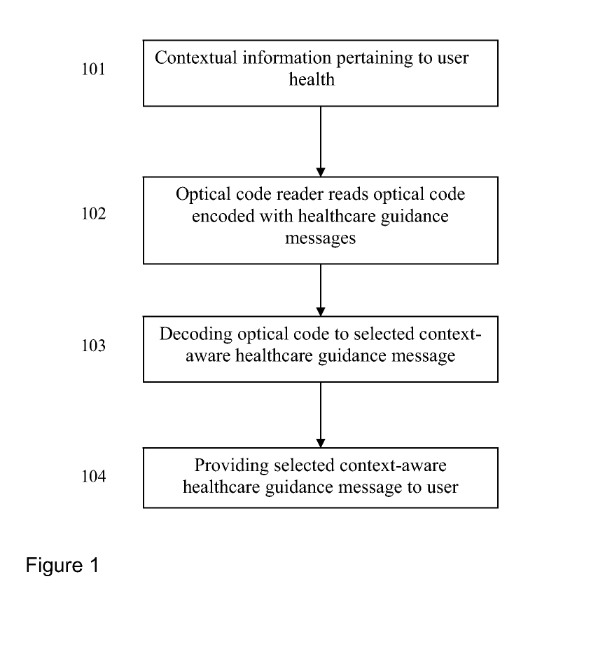

FIG. 1 shows a flowchart illustrating a method of providing context-aware guidance for healthcare according to embodiments of the present invention. Contextual information pertaining a user health 101 is received from one or more devices. Next, an optical code reader reads optical code encoded with healthcare guidance messages 102. According to embodiments of the present invention the optical code can be a barcode. The barcode can be a one-dimensional barcode or a two-dimensional barcode. The barcode can be in color. The optical code is decoded in decoding optical code to selected context-aware healthcare guidance message 103.

In decoding optical code to selected context-aware healthcare guidance message 103 a context-aware healthcare guidance message is selected using received the contextual information. A codify string pertaining to the selected context-aware healthcare message is selected. Using the codify string a key mask is generated. Using the key mask a decode key is generated which decodes the selected context-aware healthcare guidance message. In step 104, the selected context-aware healthcare guidance message is provided to user 104.

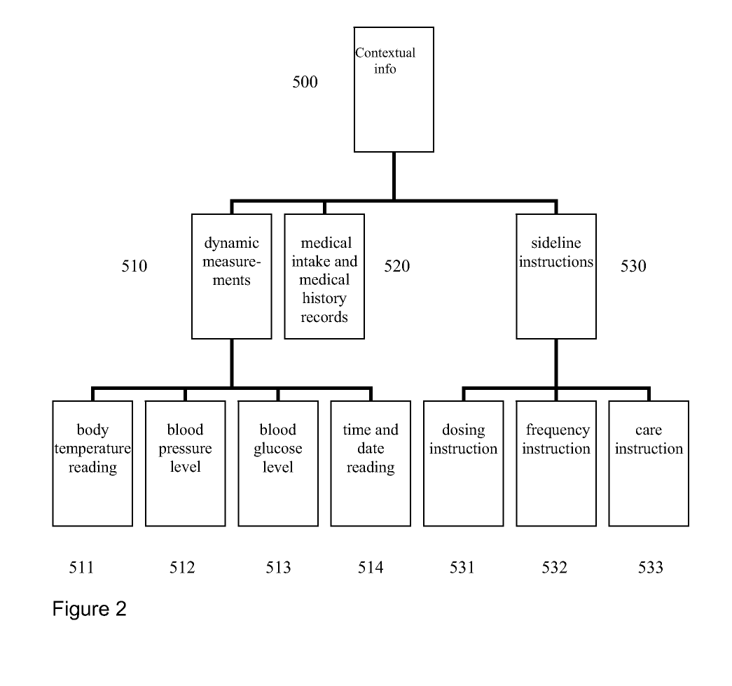

FIG. 2 is a detailed flowchart illustrating various types of contextual information pertaining to a user's health used to determine a selected context-aware healthcare guidance message according to embodiments of the present invention. The contextual information helps determine the selected context-aware healthcare guidance message.

Contextual information 500 includes three categories of information, dynamic measurements 510, medical intake and medical history records 520, and sideline instructions 530.

Dynamic measurements 510 include several types of measurements according to embodiments of the present invention. Measurements include a body temperature reading 511. For example, a user in need of medical assistance takes their body temperature. Body temperature reading 511 selects key mask. The key mask selects a decode key, to decode from the optical code, a selected context-aware healthcare guidance message. Different body temperature readings produce different instructions. For example, a body temperature reading 511 of <39° C. produces a selected context-aware healthcare guidance message instructing the user to take a fever reducing medication. A body temperature reading 511 of 39° C.<x<41° C. produces a selected context-aware healthcare guidance message instructing the user to take an antibiotic medication prescribed. Whereas, a body temperature reading 511 of >41° C. produces a selected context-aware healthcare guidance message instructing the user to seek emergency medical attention or aid.

Other dynamic measurements 510 include blood pressure level 512, blood glucose level 513, and a time and date reading 514. All of the dynamic measures concern the user's current physical state of health. A selected context-aware healthcare guidance message is formed for a user because selecting a message requires refreshed/ up-to-date measurements combined with healthcare guidance messages pertaining to the current medical condition.

Medial intake and medical history records 520 include a user's entire medical and treatment history. Including medical intake records and medical history records as contextual information is important and helps to reduce error to prescribing a treatment or course of action to a user. Sideline instructions 530 include a dosing instruction 531, a frequency instruction 532, and a care instruction 533.

Combined, all of the contextual information 500 helps to provide a context-aware healthcare guidance message. According to embodiments of the present invention, a context-aware healthcare guidance message accounts for dynamic measures 510, medical intake and medical history records 520, and sideline instructions 530.

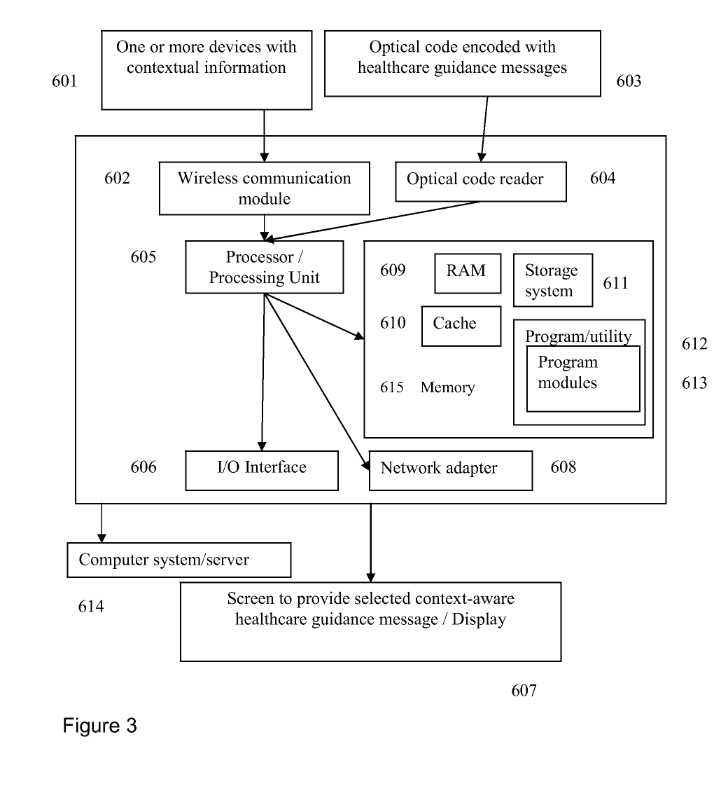

FIG. 3 is a computer system server for providing context-aware guidance for healthcare according to embodiments of the present invention. Computer system/server 614 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 614 can be practiced in a distributed cloud computing environments where tasks are performed by remote processing devices that are linked through a communications network. In a distributed cloud computing environment, program modules can be located in both local and remote computer system storage media including memory storage devices.

In computer system/server 614 a wireless communication module 602 receives contextual information from one for more devices with contextual information 601. Optical code reader 604, which can include a barcode scanner, reads optical machine-readable code. Optical machine-readable code includes optical code encoded with healthcare guidance messages 603.

As shown in FIG. 3, computer system/server 614 in cloud computing node is shown in the form of a general-purpose computing device. The components of computer system/server 614 can include, but are not limited to, one or more processors or processing units 605, a system memory 615, and a bus that couples various system components including system memory 615 to processor 605.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 614 typically includes a variety of computer system readable media. Such media may be any available media that is accessible by computer system/server 614, and it includes both volatile and non-volatile media, removable and non-removable media.

System memory 615 can include computer system readable media in the form of volatile memory, such as random access memory (RAM) 609 and/or cache memory 610. Computer system/server 614 can further include other removable/non-removable, volatile/non-volatile computer system storage media. By way of example only, storage system 611 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 615 can include at least one program product having a set (e.g., at least one) of program modules that are configured to carry out the functions of embodiments of the invention.

Program/utility 612, having a set (at least one) of program modules 613, can be stored in memory 615 by way of example, and not limitation, as well as an operating system, one or more application programs, other program modules, and program data. Each of the operating system, one or more application programs, other program modules, and program data or some combination thereof, can include an implementation of a networking environment. Program modules 613 generally carry out the functions and/or methodologies of embodiments of the invention as described herein.

Computer system/server 614 can also communicate with one or more external devices such as a keyboard, a pointing device, a display (screen to provide selected context-aware healthcare guidance message) 607, etc.; one or more devices that enable a user to interact with computer system/server 614; and/or any devices (e.g., network card, modem, etc.) that enable computer system/server 614 to communicate with one or more other computing devices. Such communication can occur via Input/Output (I/O) interfaces 606. Still yet, computer system/server 614 can communicate with one or more networks such as a local area network (LAN), a general wide area network (WAN), and/or a public network (e.g., the Internet) via network adapter 608. As depicted, network adapter 608 communicates with the other components of computer system/server 614 via the bus.

It should be understood that although not shown, other hardware and/or software components could be used in conjunction with computer system/server 614. Examples, include, but are not limited to: microcode, device drivers, redundant processing units, external disk drive arrays, RAID systems, tape drives, and data archival storage systems, etc.

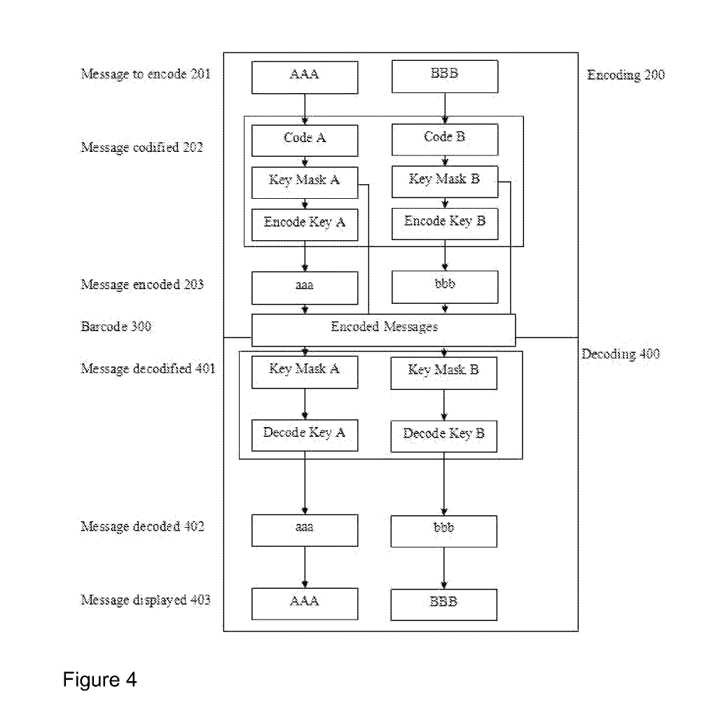

FIG. 4 is a detailed flowchart illustrating encoding a plurality of context-aware healthcare guidance messages into optical code and decoding and displaying a selected context-aware healthcare guidance message according to embodiments of the present invention.

Message to encode 201 is codified. Message to encode 201 includes the plurality of healthcare guidance messages. Encoding 200 illustrates encoding the healthcare guidance messages, according to embodiments of the present invention, into a single barcode.

Message to encode 201 encrypts the plurality of healthcare guidance messages into a plurality of coded messages, message codified 202. A message to encode 201, for example message AAA, is encrypted to produce a codified message, code A. A plurality of key masks and a plurality of encode keys are generated. Using key mask A, code A is put at a bar position. Encode key A encrypts code A is into message encoded 203, aaa.

Encoding 200 further includes writing key mask A and message encoded 203, aaa, into optical code, barcode 300. According to embodiments of the present invention, encoding 200 includes having a plurality of healthcare guidance messages (message to encode 201), codifying the healthcare guidance messages (message codified 202), encoding the healthcare guidance messages (message encoded 203), and writing the healthcare guidance messages into optical code (barcode 300). Multiple healthcare guidance messages can be encoded by different encode keys and stored in the same optical code, barcode 300, along with the key masks.

A selected context-aware healthcare guidance message is displayed to a user using decoding 400. A user receives optical code, barcode 300, with encoded healthcare guidance messages using a decode machine. At message decodified 401, a key mask A is generated based on a context-aware healthcare guidance message selected from received contextual information pertaining to the user's health. Using a key mask A, a decode key A is generated. The encoded healthcare guidance message in the optical code, barcode 300, is decoded by decode key A into the selected context-aware healthcare guidance message, message decoded 402, aaa. Message decoded 402, aaa, is displayed to the user at message displayed 403, AAA.

According to embodiments of the present invention decoding 400 includes having a plurality of healthcare guidance messages to decode, decodifying the healthcare guidance messages (message decodified 401) and healthcare guidance messages (message decoded 402) which are displayed to a user (message displayed 403). The decode keys are used to decode stored information in the optical code (barcode 300). Only relevant information, based on contextual information received is displayed.

For example, messages AAA, BBB, and CCC are generated. The messages are codified into a coded message. For example, the messages AAA, BBB, and CCC are codified to 1111, 2222, and 3333. Key masks are used to put different coded healthcare guidance messages at different bar positions in optical code. Key masks are used to generate encode keys. Encode keys are bar position information and content revelation masks.

The encode keys are used to encode healthcare guidance messages into encoded messages. For example, the messages AAA, BBB, and CCC are encoded into encoded healthcare guidance messages aaa, bbb, and ccc. Key masks and encoded healthcare guidance messages are written into encoded optical code.

The decoding procedure is based on using context-aware key masks to reveal decode keys that decode stored healthcare guidance messages according to an embodiment of the present invention.

According to embodiments of the present invention, a user having a decode machine can decode messages on a selectable barcode if the user has the codify string. Context-selected key masks are used to generate decode keys. Decode keys decode encoded healthcare guidance messages. The decoded healthcare guidance messages are displayed to a user.

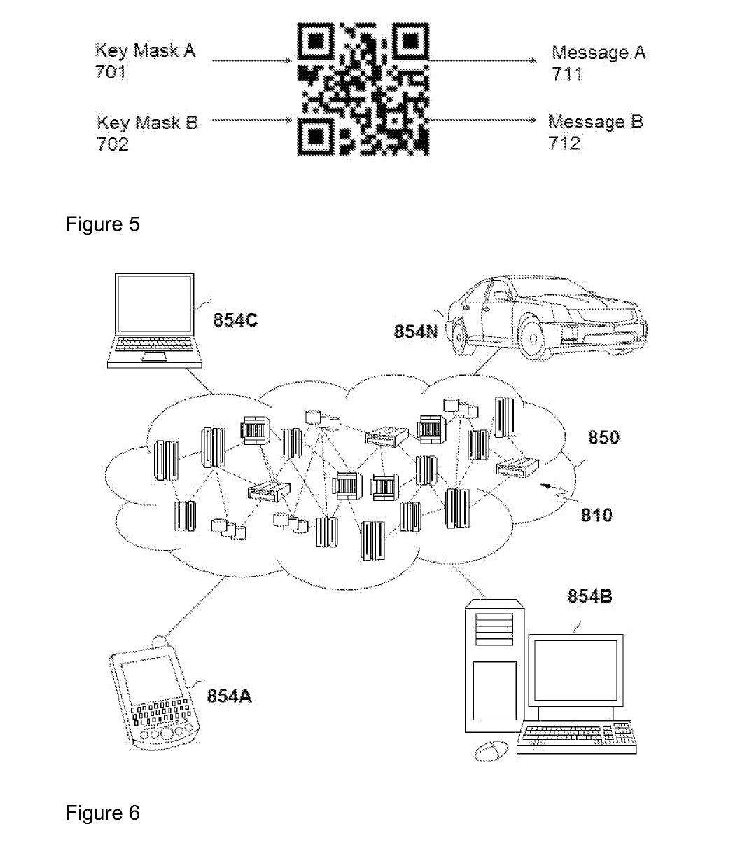

FIG. 5 shows key masks used to encode and decode messages within a barcode according to embodiments of the present invention. In the present invention optical code is used to store information and provide a selectable context-aware healthcare guidance message to a user. According to embodiments of the present invention, a barcode can store the plurality of context-aware healthcare guidance messages. Barcodes can be one-dimensional barcodes or two-dimensional barcodes. Furthermore, the barcodes can be in color or in black and white.

Key mask A 701 and key mask B 702 are written into a barcode. Encoded context-aware healthcare guidance messages are also written into the barcode. Based on the barcode a user can generate key mask A 701 and key mask B 702. Using key mask A 701 and Key Mask B 702 a user can generate decode keys to decode and then retrieve a selected context-aware healthcare guidance message, message A 711 or message B 712 from the barcode.

FIG. 6 depicts a cloud computing environment according to embodiments of the present invention. Referring now to FIG. 6, illustrative cloud computing environment 850 is depicted. As shown, cloud computing environment 850 includes one or more cloud computing nodes 810 with which local computing devices used by cloud consumers, such as, for example, personal digital assistant (PDA) or cellular telephone 854A, desktop computer 854B, laptop computer 854C, and/or automobile computer system 854N can communicate. Nodes 810 can communicate with one another. They can be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 6 are intended to be illustrative only and that computing nodes 810 and cloud computing environment 850 can communicate with any type of computerized device over any type of network and/or network addressable connection (e.g., using a web browser).

According to embodiments of the present invention, accumulating selected context-aware healthcare guidance messages can be displayed to a user. In this embodiment of the present invention a plurality of context-aware healthcare guidance message are considered together as a set of commands. The decode key contains at least one key mask to decode a plurality of context-aware healthcare guidance messages. Since the selected context-aware healthcare guidance messages are considered together, an individual selected context-aware healthcare guidance message is not displayed unless a preceding context-aware healthcare guidance message is also displayed to the user. For accumulating selected context-aware healthcare guidance messages

In embodiments of the present invention the decode key contains one key mask to decode a context-aware healthcare guidance message. Here, individual or a parallel selected context-aware healthcare guidance message can be displayed. The context-aware healthcare guidance messages are not considered together as a set of commands. Parallel processing is useful when the messages are displayed to different personnel in a work pipeline.

In embodiments of the present invention a prefix can be used to hide failed decoding. A prefix is used to add an extra layer of security protection in the optical code. A codified message is encrypted using a prefix and an encode key into a codified message. If the decoder finds a prefix, for example “̂”, the decoder knows that it has successfully seen the decoded the context-aware healthcare guidance message without confusion. If the decoder does not see “̂” in the beginning of the decoded message, it is a failure. The context-aware healthcare guidance message is only displayed if the decode key finds the set prefix when decoding.

Additionally, encode/decode Keys using a default subtraction value according to an embodiment of the present invention, can be used. If context information is numeric, by creating a default subtraction value an encode or decode key can be generated. The encode and decode keys can be generated without codifying messages in advance, thus the step of producing the codified messages is not required.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium may be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection can be made to an external computer (for example, through the Internet using an Internet Service Provider).

Computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts of the present invention.

The computer program instructions can also be stored in a computer readable medium that can direct a computer, other programmable data processing apparatus, or other devices to function in a particular manner, such that the instructions stored in the computer readable medium produce an article of manufacture including instructions which implement the function/act of the present invention. The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus. It should also be noted that, in some alternative implementations, the functions noted in can occur in a different order.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An device for providing context-aware guidance for healthcare, the device comprising:
a wireless communication module configured to receive contextual information pertaining to a user's health from one or more devices;
an optical code reader to read an optical code encoded with a plurality of healthcare guidance messages;
a processor to decode the optical code encoded with the plurality of healthcare guidance messages into a selected context-aware healthcare guidance message using the received contextual information pertaining to the user's health; and
a screen for providing the selected context-aware healthcare guidance message to the user.

2. The device according to claim 1, wherein the contextual information pertaining to the user's health, further comprises a plurality of dynamic measurements including a temperature, a blood pressure, a glucose level, or a time reading.

3. The device according to claim 1, wherein the contextual information pertaining to the user's health, further comprises a medical intake record and a medical history record.

4. The device according to claim 1, wherein the contextual information pertaining to the user's health, further comprises a plurality of sideline instructions including a dosing instruction, a frequency instruction, or a care instruction.

5. The device according to claim 1, wherein the device is a cellular mobile device.

6. The device according to claim 1, wherein the wireless communication module further comprises a module for communicating in a Near Field Communication network.

7. The device according to claim 1, wherein the optical code encoded with the plurality healthcare guidance messages is a barcode.

8. The device according to claim 7, wherein the barcode is a two-dimensional barcode.

9. The device according to claim 1, wherein the plurality of healthcare guidance messages are dynamically packaged in a Cloud service database, wherein the Cloud service database is dynamically updated.

10. A method of providing context-aware guidance for healthcare, the method comprising:
receiving contextual information pertaining to a user's health from one or more devices;
reading an optical code using an optical code reader, wherein the optical code is encoded with a plurality of healthcare guidance messages;
decoding the optical code encoded with the plurality healthcare guidance messages into a selected context-aware healthcare guidance message using the received contextual information pertaining to the user's health; and
providing the selected context-aware healthcare guidance message to the user.

11. The method according to claim 10, wherein the optical code encoded with the plurality healthcare guidance messages is a barcode.

12. The method according to claim 11, wherein the barcode is a two-dimensional barcode.

13. The method according to claim 10, wherein decoding the optical code into the selected context-aware healthcare guidance message, further comprises:
receiving contextual information pertaining to the user's health;
selecting from the plurality of healthcare guidance messages a context-aware healthcare guidance message using the contextual information;
extracting a codify string pertaining to the selected context-aware healthcare guidance message;
generating a key mask using the codify string;
obtaining a decode key using the key mask; and
receiving the selected context-aware healthcare guidance message using the decode key.

14. The method according to claim 10, wherein encoding the plurality of healthcare guidance messages into optical code, further comprises:
encrypting the plurality of healthcare guidance messages into a plurality of coded messages;
generating a plurality of key masks and a plurality of encode keys, wherein a key mask sets a coded message at a bar position and, wherein an encode key processes a coded message into an encoded message; and
writing a plurality of encoded messages into optical code.

15. The method according to claim 13, wherein the decode key contains at least one key mask to decode a plurality of context-aware healthcare guidance messages.

16. The method according to claim 10, wherein the plurality of healthcare guidance messages are dynamically packaged in a Cloud service database, wherein the Cloud service database is dynamically updated.

17. An optical machine-readable code for providing context-aware guidance for healthcare, the code comprising:
an optical code storing a plurality of healthcare guidance messages and encoded in a manner that one of the plurality of healthcare guidance messages can be selected using a decode key, wherein the optical code is provided on a container for medication.

18. The optical machine-readable code according to claim 17, wherein selecting one of the plurality of healthcare guidance messages using a decode key, further comprises:
receiving contextual information pertaining to the user's health;
selecting a context-aware healthcare guidance message using the contextual information;
extracting a codify string pertaining to the context-aware healthcare guidance message;
generating a key mask using the codify string;
obtaining a decode key using the key mask; and
receiving from the context-aware healthcare guidance message.

19. The optical machine-readable code according to claim 17, wherein the optical code storing a plurality of healthcare guidance messages is a barcode.

20. The optical machine-readable code according to claim 17, wherein the plurality of healthcare guidance messages are dynamically packaged in a Cloud service database, wherein the Cloud service database is dynamically updated.
